(19) United States
(12) Patent Application Publication
(10) Pub. No.: US 2025/0243706 A1
(43) Pub. Date: Jul. 31, 2025

(54) PRESSING CONNECTION FOR CURTAIN AND WINDOW WALLS

(71) Applicant: Arconic Technologies LLC, Pittsburgh, PA (US)

(72) Inventor: Raymond GLOVER, Runcorn (GB)

(73) Assignee: Arconic Technologies LLC, Pittsburgh, PA (US)

(21) Appl. No.: 18/981,027

(22) Filed: Dec. 13, 2024

(30) Foreign Application Priority Data
Jan. 26, 2024 (EP) 24154105.01

(51) Int. Cl. E06B 1/32; E06B 1/36; E06B 1/60

(52) U.S. Cl. CPC E06B 1/325; E06B 1/366; E06B 1/6046

(57) ABSTRACT

A curtain wall or window wall for a building including a frame including a plurality of frame units composed of frame members, wherein the frame members comprise mullions. A plurality of infill panels are supported by and received within the plurality of frame units, and one or more thermally insulating elements. Each frame unit comprises a plurality of metal fastening elements for retaining infill panels within a corresponding one of the frame units. Each metal fastening element comprises a first end in contact with the mullions and a second end spaced from the first end. The second end of each metal fastening element, having the first end in contact with the mullions forming a first outer edge of the frame, contacts one of the thermally insulating elements. Each of the thermally insulating elements comprises at least one means for attachment to a pressing.

### TECHNICAL FIELD

The present disclosure generally relates to curtain walls and window walls for buildings and, more specifically, to a pressing connection for a curtain wall or a window wall and to a curtain wall or window wall comprising a plurality of said pressing connections.

### BACKGROUND

A curtain wall is an outer covering of a building that may span multiple floors. A curtain wall is non-load bearing in that it does not carry the structural load of the building, other than its own dead weight. As curtain walls are non-load bearing, they may be fabricated from lightweight materials to reduce construction costs. Curtain walls may be designed to keep weather out by resisting air and water infiltration into the building. Furthermore, curtain walls may be designed to accommodate thermal expansion and contraction, and to absorb building sway induced by wind and/or seismic forces. Loads that are imposed on a curtain wall may be transferred to the building through floor anchors that connect the curtain wall to the floor structures of the building.

A window wall is similar to a curtain wall in structure and purpose (e.g., forming a weather-resistive barrier). However, unlike curtain walls, which are structurally independent of the floor structures of a building and installed beyond the edge of the floor structures, a window wall spans only a single floor and sits between and is supported by the floor structures of a building. Like curtain walls, window walls are not load-bearing in that they do not carry the structural load of the floor structures of the building in which they are installed.

Both a curtain wall and a window wall may be composed of a frame formed from a plurality of horizontal and vertical members. The horizontal and vertical members of the frame may connect to form frame units that receive infill panels of an infill material such as glass, metal, or stone veneer. The vertical members of the frame may be formed from vertical mullions, and the horizontal members of the frame may be formed from transoms or horizontal mullions. The vertical mullions and the horizontal mullions may be formed from a lightweight material, such as extruded aluminum or aluminum alloy. The vertical and horizontal mullions may assemble with gaskets and pressure plates to create a glazing pocket configured to capture and form a seal with the infill panels.

Generally, cover plates, herein “pressings”, are attached to an exterior face of the frame (i.e., the face of the frame that faces outwards, towards the outside of a building, when the curtain or window wall is attached to or installed in a building). These pressings have both an aesthetic function, influencing the external appearance of the curtain or window wall, and a weatherproofing function, helping to prevent air and water infiltrating the curtain or window wall. Pressings may be attached to the frame to cover and seal all of the vertical and horizontal members of the frame. Alternatively, pressings may be attached to the frame so as to cover and seal only some of the vertical and horizontal members of the frame, e.g., pressings may be attached to the frame so as to cover only vertical and horizontal members forming one, more or all of the outer edges (i.e. one, more or all sections of the perimeter) of the frame. Often, pressings are formed of a metal (e.g., aluminum, an aluminum alloy or zinc) having a high thermal conductivity.

An important role of curtain and window walls is to provide thermal insulation to the building to which they are attached. To improve the thermal efficiency of curtain walls and window walls, i.e., to reduce the transfer of thermal energy between the inside and the outside of the building to which the curtain wall or window wall is attached, most curtain and window walls comprise one or more thermal breaks. Each thermal break is formed from a material having a low thermal conductivity, typically a thermoplastic, and may be located in the curtain wall or window wall so as to prevent pressings contacting components of the curtain or window wall having a high thermal conductivity, e.g., mullions formed from extruded aluminum or aluminum alloy. However, curtain and window walls typically contain fastening elements and connecting brackets made of a material having a high thermal conductivity, e.g., aluminum or aluminum alloy, that penetrate thermal breaks, interfering with the insulation of the building and creating “thermal bridges” (i.e., localized areas of the building envelope where the heat flow is increased between the inside and the outside of the building). These thermal bridges reduce the effectiveness of the insulation of the building.

Thus, there is a need for curtain and window wall systems which provide improved thermal insulation.

### SUMMARY OF THE DISCLOSURE

According to a first aspect, there is provided a curtain wall or a window wall for a building comprising: a frame including a plurality of frame units composed of frame members, wherein the frame members comprise mullions; a plurality of infill panels supported by and received within the frame units; and one or more thermally insulating elements, wherein each frame unit comprises a plurality of metal fastening elements for retaining one of the infill panels within the frame unit, wherein each fastening element comprises a first end in contact with one of the mullions and a second end spaced from the first end, wherein the second end of each metal fastening element having the first end in contact with a mullion of the one or more frame members forming a first outer edge of the frame contacts one of the one or more thermally insulating elements, wherein each of the one or more thermally insulating elements comprises at least one means for attachment to a pressing.

The mullions may be formed from aluminum or aluminum alloy.

The second end of each metal fastening element having the first end in contact with a mullion of the one of more frame members forming a second outer edge of the frame contacts one of the one or more thermally insulating elements. Further, the second end of each metal fastening element having the first end in contact with a mullion of the one of more frame members forming a third outer edge of the frame contacts one of the one or more thermally insulating elements.

Each thermally insulating element may be formed of ABS (acrylonitrile butadiene styrene) or uPVC (unplasticized polyvinyl chloride). Preferably, each thermally insulating element is formed of uPVC.

Preferably, the means for attachment to a pressing is a pop rivet. Alternatively, the means for attachment to a pressing may be an aperture for receiving a pop rivet therethrough.

Each thermally insulating element may comprise a plurality of means for attachment to a pressing. The plurality of means for attachment may be spaced at intervals of 150 mm or less along a length of said thermally insulating element. Preferably, the means for attachment are spaced at intervals of 100 mm or less.

Each thermally insulating element may comprise an L-shaped cross-section.

Each thermally insulating element may be attached to the frame via a plurality of fixing elements, preferably wherein the fixing elements are spaced at intervals of no greater than 300 mm along a length of the thermally insulating element, most preferably wherein the fixing elements are spaced at intervals of from 250 mm to 300 mm along the length of the thermally insulating element.

Preferably, each frame member comprises a plurality of fastening elements.

In another aspect, there is provided a curtain or window wall system, wherein the curtain or window wall system comprises a curtain wall or window wall as disclosed herein and one or more pressings for attachment to the curtain wall or window wall.

Preferably, the one or more pressings are of aluminum, aluminum alloy or zinc. Advantageously, the one or more pressing are of aluminum or aluminum alloy.

These and other aspects and features of the present disclosure will be more readily understood when read in conjunction with the accompanying drawings. Moreover, it must be noted that the various features of any of the above statements may be combined without restriction, as will be readily appreciated by those skilled in the art.

### BRIEF DESCRIPTION OF THE DRAWINGS

FIG. 1 is a front view of an exemplary curtain wall in accordance with the present disclosure.

FIG. 2A is a perspective view of a section of a curtain wall of the prior art having a pressing attached thereto.

FIG. 2B is cross-sectional view depicting the attachment of the pressing to the curtain wall of FIG. 2A.

FIG. 3A is a perspective view of a section of a curtain wall in accordance with the present disclosure having a pressing attached thereto.

FIG. 3B is a cross-sectional view depicting the attachment of the pressing to the curtain wall of FIG. 3A.

### DETAILED DESCRIPTION

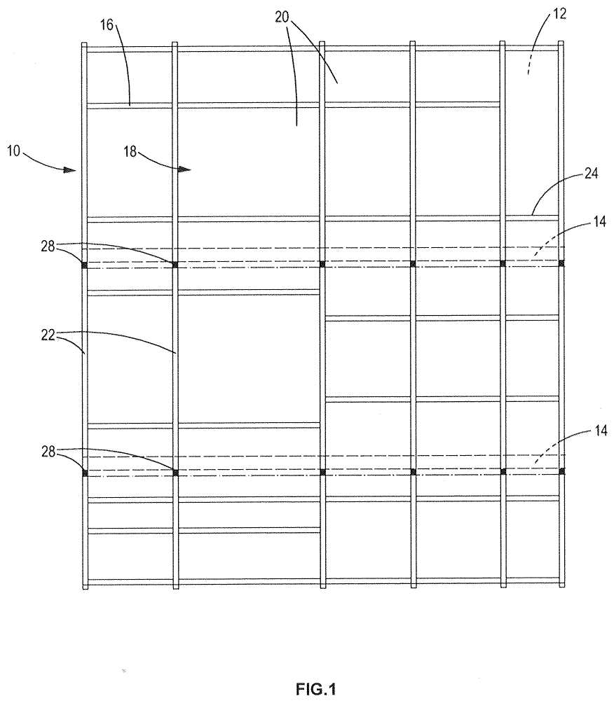

Referring now to the drawings, and with specific reference to FIG. 1, a curtain wall 10 for attachment to a building 12 is shown. The curtain wall 10 may provide an outer covering for a building 12. As is understood by those with ordinary skill in the art, the curtain wall 10 may provide a weather barrier that resists air and/or water infiltration into the building 12. It may further absorb building sway caused by various forces acting on the building 12.

The curtain wall 10 includes a frame 16 for anchoring to a building 12. It may, for example, be anchored to floor structures 14 of the building 12. The frame 16 comprises a plurality of frame units 18 that support infill panels 20. The infill panels 20 may be panels of an infill material such as, but not limited to, glass, metal, or stone veneer. The frame 16 may be composed of a plurality of frame members 22, 24, e.g., vertical members 22 and horizontal members 24, that interconnect to form the frame units 18. The frame members 22, 24 may comprise mullions, e.g., vertical mullions and horizontal mullions/transoms. The mullions may be formed from a lightweight material such as, but not limited to, extruded aluminum or aluminum alloy.

It should be appreciated that curtain walls according to the principles of the present disclosure may comprise any desired number of frame units 18 and infill panels 20. The number of frame units 18 and infill panels 20 depicted in FIG. 1 is not intended to be limiting.

It should also be noted that curtain walls according to the principles of the present disclosure need not be limited to arrangements that comprise horizontal members 24 and vertical members 22 and co-planar infill panels 20, such as the arrangement depicted in FIG. 1. Arrangements will be possible, for example, in which frame members are provided at an oblique angle to one another and/or in which the infill panels 20 are other than co-planar to one another.

In preferred arrangements, the infill panels 20 comprise glass and the curtain wall 10 is a silicone structural glazing (SSG) system.

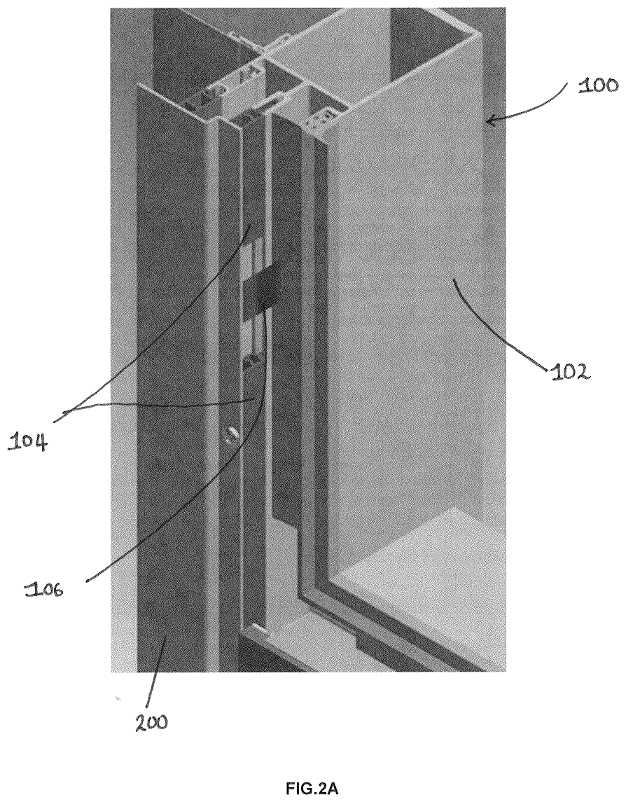

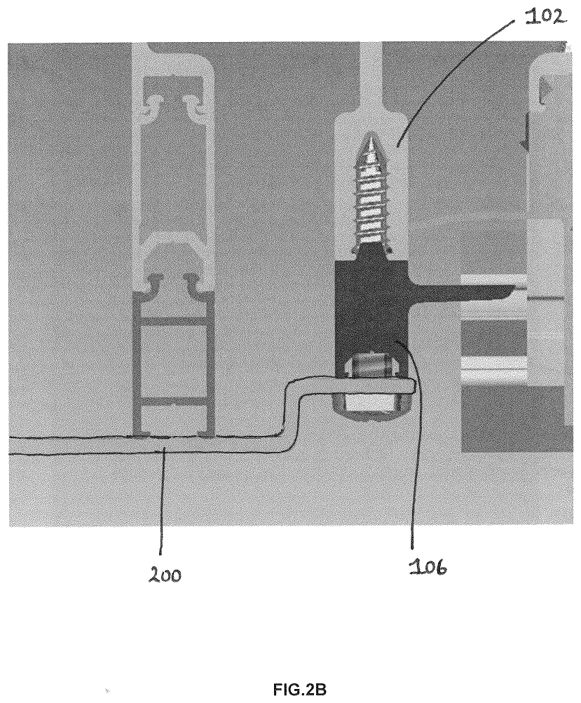

FIG. 2A depicts a section of a curtain wall of the prior art. Specifically, FIG. 2A depicts a section of a frame unit of the prior art. The frame unit comprises a frame member 100, wherein the frame member 100 comprises: a mullion 102; a thermal break 104; and a fastening element 106. A pressing 200 is shown attached to the frame member 100. Most commonly, mullion 102 and pressing 200 are formed of materials having a high thermal conductivity, e.g., aluminum or aluminum alloy. The thermal break 104, made from a material having a low thermal conductivity, is located between the mullion 102 and the pressing 200, to reduce the flow of thermal energy between the mullion 102 and the pressing 200. This, in turn, reduces the flow of thermal energy between the inside and the outside of the building to which the curtain wall is attached.

As can be seen in FIG. 2A, the fastening element 106 penetrates between sections of the thermal break 104 to contact the pressing 200. FIG. 2B depicts the attachment of the pressing 200 to the frame member 100 in more detail. The pressing 200 directly contacts the fastening element 106, which, in turn, directly contacts the mullion 102. Typically, fastening element 106 is also formed from a material having a high thermal conductivity, e.g., aluminum or aluminum alloy. As such fastening element 106 forms a thermal bridge, allowing thermal energy to readily flow between the mullion 102 and the pressing 200 and, thereby, between the inside and the outside of the building to which the curtain wall is attached.

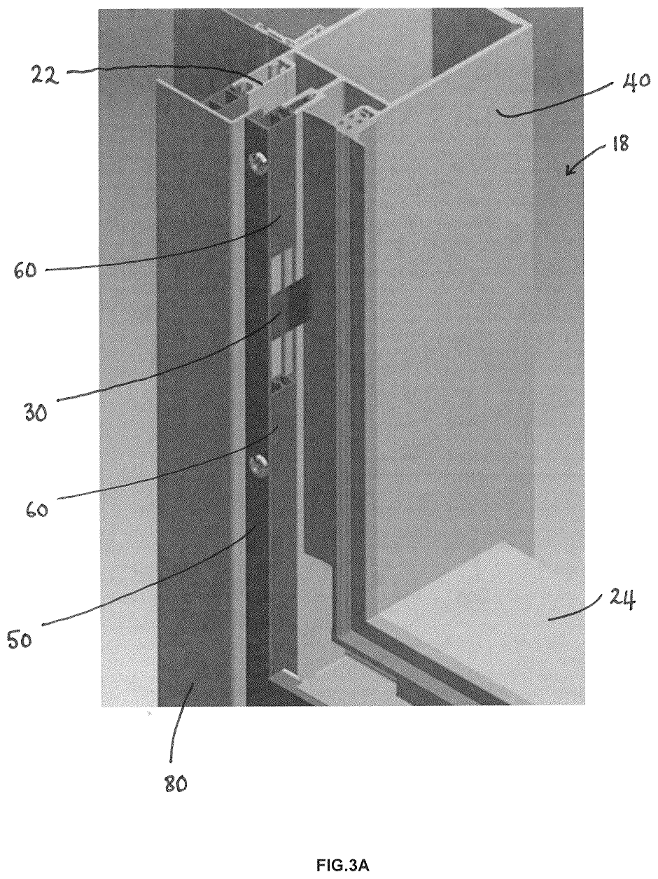

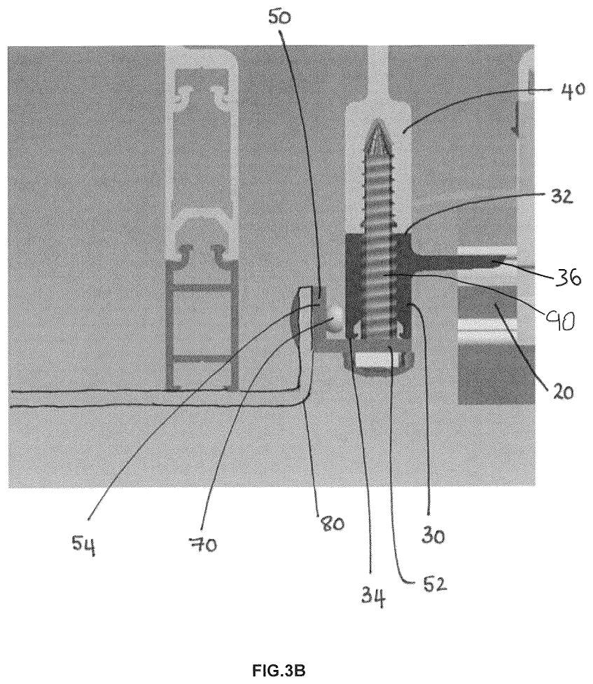

Turning now to FIG. 3A, which depicts a section of a frame unit 18 in accordance with the present disclosure having a pressing 80 attached thereto, a frame unit 18 in accordance with the present disclosure comprises a plurality of fastening elements 30 for retaining an infill panel 20 within the frame unit 18. Each frame member 22, 24 forming a frame unit 18 may comprise at least one fastening element 30 for retaining an infill panel 20 within the frame unit 18. In preferred arrangements, each frame member 22, 24 forming a frame unit 18 comprises multiple fastening elements 30 for retaining an infill panel 20 within the frame unit 18. Typically, the fastening elements 30 are spaced at intervals of from 75 mm to 400 mm along the frame member 22, 24, to allow the infill panel 20 to be securely retained within the frame unit 18 while avoiding unnecessarily increasing the overall weight of the frame unit 18. The exact spacing interval will depend on a number of factors, including infill panel 20 size and the maximum wind load the curtain wall/window wall 10 is expected to be subjected to.

Referring now to FIG. 3B, each fastening element 30 comprises a first end 32 in direct contact with a mullion 40 of a frame member 22, 24. Each fastening element additionally comprises a second end 34 spaced from the first end 32. The fastening elements 30 in accordance with the present disclosure may take a variety of shapes and forms. In a preferred arrangement, as depicted in FIG. 3B, the fastening elements 30 are toggles. The toggles comprise at least one arm 36 for retaining an infill panel 20 within the frame unit 18.

The fastening elements 30 are made of metal. Therefore, the fastening elements 30 are good thermal conductors. In preferred arrangements, the fastening elements are made of aluminum or an aluminum alloy. Aluminum and aluminum alloys are preferred because they are both strong and lightweight (i.e., have a desirable strength to weight ratio), helping reduce the overall weight of the frame unit 18 and, thereby, the curtain wall 10.

The frame unit 18 depicted in FIGS. 3A and 3B is formed from a frame member 22, which forms part of an outer edge of the frame 16 of the curtain wall 10. The second end 34 of each at least one fastening element 30 of the frame member 22 contacts a thermally insulating element 50. The thermally insulating element 50 is formed from a material having a low thermal conductivity, i.e., a W/mK value of less than 1 at 25° C. In preferred arrangements, the thermally insulating element 50 is formed from uPVC (unplasticized polyvinyl chloride), which offers a desirable combination of good rigidity and low thermal conductivity. In other preferred arrangements, the thermally insulating element 50 is formed from ABS (Acrylonitrile Butadiene Styrene).

In preferred arrangements, as depicted, the thermally insulating element 50 extends along the entire length of the frame member 22 and contacts each at least one fastening element 30 of the frame member 22. In alternative arrangements, multiple thermally insulating elements 50 may be attached to the frame member 22, e.g., each thermally insulating element 50 may extend along only a fraction of the entire length of the frame member 22.

A curtain wall 10 in accordance with the present disclosure may comprise multiple thermally insulating elements 50. For example, in some arrangements, the curtain wall 10 comprises one or more thermally insulating elements 50 attached to the one or more frame members 22, 24 forming each of three outer edges, e.g., bottom, left side and right side, of the frame 16. In alternative arrangements, the curtain wall 10 comprises one or more thermally insulating elements 50 attached to the one or more frame members 22, 24 forming each and all outer edges of the frame 16 (e.g, bottom, top, left side and right side).

As depicted in FIG. 3B, the thermally insulating element 50 may be attached to the frame 16 (i.e., frame members 22, 24) via one or more fixing elements 90 (i.e., fastening elements 90). In preferred arrangements, as depicted, the fixing element 90 is a screw. Preferably, the thermally insulating element 50 is attached to the frame 16 via a plurality of fixing elements 90. In particularly preferred arrangements, the fixing elements 90 are spaced at intervals of no greater than 300 mm along a length of the thermally insulating element 50, more preferably at intervals of from 250 mm to 300 mm along a length of the thermally insulating element 50. Spacing the fixing elements 90 at intervals of 300 mm or less allows the thermally insulating element 50 to be securely fastened to the frame 16, while avoiding unnecessarily increasing the overall weight of the frame 16. For example and as depicted, the thermally insulating element 50 may be attached to one or more fastening elements 30 via one or more fixing elements 90.

As depicted in FIG. 3B, a thermally insulating element 50 comprises at least one means 70 for attachment to a pressing 80. In preferred arrangements, the means 70 for attachment to a pressing 80 is a pop rivet or an aperture for receiving a pop rivet. A pop rivet is preferred due to its small size. For example, a pop rivet can be introduced to attach a thermally insulating element 50 to a pressing 80 without the pop rivet interfering with and requiring modification of other components of the frame member 22.

In preferred arrangements, each thermally insulating element 50 comprises multiple means 70 for attachment to a pressing 80. For example, where a thermally insulating element 50 extends along the entire length of a frame member 22, the thermally insulating element 50 should preferably comprise multiple means 70 for attachment to a pressing 80. Advantageously, each thermally insulating element 50 comprises multiple means 70 for attachment to a pressing 80, wherein the means 70 are spaced at intervals of 150 mm or less, preferably 100 mm or less, along a length of the thermally insulating element 50. Spacing the means 70 at intervals of 150 mm or less, more particularly 100 mm or less, allows a pressing 80 to be securely attached to the thermally insulating element 50.

As can be appreciated, the thermally insulating element 50 prevents direct contact between the metal fastening element 30 and pressing 80, thereby reducing flow of thermal energy between the metal fastening element 30 and pressing 80. Accordingly, the insulating element 50 prevents formation of a thermal bridge, involving fastening element 30 and pressing 80, between the inside and the outside of the building to which the curtain wall 10 is attached. The inclusion of one or more thermally insulating elements 50 in the curtain wall 10, therefore, improves the thermal insulation properties of the curtain wall 10.

In the arrangement depicted in FIG. 3B, where the thermally insulating element 50 is attached to the fastening element 30 via a fixing element 90, a thermal bridge involving the fixing element 90, between the inside and the outside of the building to which the curtain wall 10 is attached, is still formed. In such an arrangement, while the transfer of thermal energy between the inside and outside of the building at the location of the fastening element is not completely avoided, it is significantly reduced by the introduction of thermally insulating element 50. The thermal insulation properties of the curtain wall are nevertheless improved.

In the depicted arrangement of FIGS. 3A and 3B, the thermally insulating element 50 comprises an L-shaped cross-section. This constitutes a preferred arrangement. A first portion 52 of the L-shaped thermally insulating element 50 may contact one or more fastening elements 30. A second portion 54, projecting at about 90° from the first portion 52 from the L-shaped thermally insulating element 50, may comprise the at least one means 70 for attachment to a pressing 80. Other possible cross-sectional shapes of the thermally insulating element 50 and arrangements of the thermally insulating element 50 with respect to the components of the frame member 22 are envisaged. FIGS. 3A and 3B should not be taken as limiting on the scope of the appended claims.

In preferred arrangements, particularly wherein the curtain wall 10 is a SSG system, the thermally insulating element 50 has a thickness of about 2 mm.

The above detailed description relates to an arrangement in which only fastening elements 30 of frame members 22, 24 forming outer edges (i.e., the perimeter) of the frame 16 contact a thermally insulating element 50. In SSG systems, a pressing 80 is typically only attached to frame members 22, 24 forming one, more or all outer edges of the frame 16. The remaining frame members 22, 24 of the frame 16 are sealed with a high-strength, high-performance silicone sealant. This sealant has a low thermal conductivity and thereby prevents formation of thermal bridges between the inside and the outside of the building to which the curtain wall is attached. Accordingly, the above-described arrangement is particularly suitable for application to SSG systems.

In alternative arrangements, where an additional pressing or additional pressings 80 are to be attached to the curtain wall 10, further fastening elements 30 of the frame 16, i.e., in addition to fastening elements 30 of frame members 22, 24 forming outer edges of the frame 16, may contact a thermally insulating element 50 as described in detail above.

While the above detailed description refers exclusively to a curtain wall 10, a person of ordinary skill in the art will readily appreciate that a window wall may also comprise any and all of the above disclosed features, e.g., a plurality of fastening elements 30 and at least one thermally insulating element 50.

The disclosed systems are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the appended claims. It is therefore evident that the particular illustrative embodiments disclosed above may be altered, combined, or modified and all such variations are considered within the scope of the present disclosure. The systems illustratively disclosed herein may suitably be practiced in the absence of any element that is not specifically disclosed herein and/or any optional element disclosed herein. While systems are described in terms of “comprising,” “containing,” or “including” various components, the systems can also “consist essentially of” or “consist of” the various components. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Although various example embodiments have been disclosed, a person of ordinary skill in this art would recognize that certain modifications would fall within the scope of the appended claims. For that reason, the appended claims should be studied to determine the scope and content of this disclosure.

What is claimed is:

1. A curtain wall or window wall for a building, comprising:
a frame including a plurality of frame units composed of frame members, wherein the frame members comprise mullions;
a plurality of infill panels supported by and received within the plurality of frame units; and
one or more thermally insulating elements,
wherein each frame unit comprises a plurality of metal fastening elements for retaining one of the plurality of infill panels within a corresponding one of the plurality of frame units,
wherein each metal fastening element comprises a first end in contact with one of the mullions and a second end spaced from the first end,
wherein the second end of each metal fastening element, having the first end in contact with the one of the mullions forming a first outer edge of the frame, contacts one of the one or more thermally insulating elements, and
wherein each of the one or more thermally insulating elements comprises at least one means for attachment to a pressing.

2. The curtain wall or window wall of claim 1, wherein the mullions are formed from aluminum or aluminum alloy.

3. The curtain wall or window wall of claim 1, wherein:
the second end of each metal fastening element, having the first end in contact with a mullion of the one of more frame members forming a second outer edge of the frame, contacts one of the one or more thermally insulating elements; and
the second end of each metal fastening element, having the first end in contact with a mullion of the one of more frame members forming a third outer edge of the frame, contacts one of the one or more thermally insulating elements.

4. The curtain wall or window wall of claim 1, wherein each thermally insulating element is formed of acrylonitrile butadiene styrene (ABS) or unplasticized polyvinyl chloride (uPVC).

5. The curtain wall or window wall of claim 1, wherein each thermally insulating element is formed of unplasticized polyvinyl chloride (uPVC).

6. The curtain wall or window wall of claim 1, wherein the means for attachment to the pressing is a pop rivet.

7. The curtain wall or window wall of claim 1, wherein the means for attachment to the pressing is an aperture for receiving a pop rivet therethrough.

8. The curtain wall or window wall of claim 1, wherein the at least one means for attachment to the pressing comprises a plurality of means for attachment to the pressing, and wherein the plurality of means for attachment are spaced at intervals of 150 mm or less along a length of the thermally insulating element.

9. The curtain wall or window wall of claim 1, wherein the at least one means for attachment to the pressing comprises a plurality of means for attachment to the pressing, and wherein the plurality of means for attachment are spaced at intervals of 100 mm or less along a length of the thermally insulating element.

10. The curtain wall or window wall of claim 1, wherein each thermally insulating element comprises an L-shaped cross-section.

11. The curtain wall or window wall of claim 1, wherein each thermally insulating element is attached to the frame via a plurality of fixing elements.

12. The curtain wall or window wall of claim 11, wherein the fixing elements are spaced at intervals of no greater than 300 mm along a length of the thermally insulating element.

13. The curtain wall or window wall of claim 11, wherein the fixing elements are spaced at intervals of from 250 mm to 300 mm along the length of the thermally insulating element.

14. A curtain wall or window wall for a building, comprising:
a frame including a plurality of frame units composed of frame members, wherein the frame members comprise mullions;
a plurality of infill panels supported by and received within the plurality of frame units, wherein each frame unit comprises a plurality of metal fastening elements for retaining one of the plurality of infill panels within a corresponding one of the plurality of frame units;
one or more thermally insulating elements operatively coupled to the frame members; and
one or more pressings operatively coupled to the one or more thermally insulating elements,
wherein each metal fastening element comprises a first end in contact with one of the mullions and a second end spaced from the first end, and
wherein the second end of each metal fastening element, having the first end in contact with the one of the mullions forming a first outer edge of the frame, contacts one of the one or more thermally insulating elements.

15. The curtain wall or window wall of claim 14, wherein the one or more pressings are made of aluminum, an aluminum alloy, or zinc.

16. The curtain wall or window wall of claim 14, wherein the one or more pressings are made of aluminum or an aluminum alloy.

17. The curtain wall or window wall of claim 14, wherein each of the one or more thermally insulating elements comprises at least one means for attachment to a corresponding one of the one or more pressings.
